(19) United States
(12) Patent Application Publication
(10) Pub. No.: US 2016/0345319 A1
(43) Pub. Date: Nov. 24, 2016

(54) OFDMA SYSTEM AND CONTROL METHOD BASED ON MESH NETWORK

(71) Applicant: KZ BROADBAND TECHNOLOGIES, LTD, Shenzhen (CN)

(72) Inventors: Zongyi Zhou, Shenzhen (CN); Xiaoru Liao, Shenzhen (CN); Jinpeng Cheng, Shenzhen (CN)

(21) Appl. No.: 15/181,396

(22) Filed: Jun. 13, 2016

Related U.S. Application Data
(63) Continuation of application No. PCT/CN2014/090260, filed on Nov. 4, 2014.

(30) Foreign Application Priority Data
Apr. 1, 2014 (CN) 201410128764.9

(51) Int. Cl. H04W 72/04; H04W 40/22; H04W 56/00; H04L 5/00; H04W 4/02

(52) U.S. Cl. CPC H04W 72/0446; H04L 5/0007; H04W 4/025; H04W 72/0453; H04W 56/0015; H04W 40/22; H04W 84/18

(57) ABSTRACT

The present invention provides an OFDMA system based on a Mesh network. The OFDMA system comprises the Mesh network and several orthogonal and nonoverlapping data blocks divided on a time domain and a frequency domain. Several nodes are comprised inside the Mesh network, and each node is connected with one or more nodes. The data blocks are configured with a reserved gap in front of the time domain. Said several nodes include a control node to which synchronization signals corresponding to the nodes is accessed, so that the signals from the nodes are synchronized with that from the control node. The control node controls and coordinates transmission and scheduling of data blocks of the nodes with communication protocols; and the control node is used for controlling and managing data blocks required together in the Mesh network and their arrangement forms.

### CROSS-REFERENCE TO RELATED APPLICATIONS

The present application is a Continuation application of PCT application No. PCT/CN2014/090260 filed on Nov. 4, 2014, which claims the benefit of Chinese Patent Application No. 201410128764.9 filed on Apr. 1, 2014, the contents of which are hereby incorporated by reference.

### TECHNICAL FIELD

The present invention relates to the technical field of communication, and more particularly to an OFDMA system based on a Mesh network and a control method therefor.

### BACKGROUND

Frequency Division Multiple Access/Address (FDMA) is a technology in data communication and can be used to implement channel sharing. Different users are distributed to channels that have the same timeslot but different frequencies. According to this technology, frequency bands that are centrally controlled in a frequency division multiple access/address transmission system are allocated to users according to requirements. Compared with a fixed allocation system, frequency division multiple access/address enables the channel capacity to be dynamically changed according to requirements. Frequency division multiple access/address adopts a multiple access technology of frequency modulation, and a service channel is allocated in different frequency bands to different users, for example, a TAS system and an AMPS system.

Time Division Multiple Access (TDMA) is to divide time into periodic frames, and each frame is further divided into one or more timeslots for sending a signal to a base station. Provided that timing and synchronization are ensured, the base station can receive the signals of each mobile terminal in every timeslot without interference. Meanwhile, the signals sent by the base station to multiple mobile terminals are scheduled and transmitted in sequence in predetermined timeslots, and each mobile terminal only needs to perform reception in a specified timeslot, and can identify and receive the signal sent to the mobile terminal from combined signals. TDMA is applied to digital cellular telephone system communications, in which each cellular channel is divided into three timeslots, so that the total volume of data carried on the channel can be increased. TDMA is applied to a North America Digital-Advanced Mobile Phone System (D-AMPS), a Global System for Mobile Communications (GSM) and a Personal Digital Cellular (PDC) system.

Code Division Multiple Access (CDMA) is a technology used in wireless communications. CDMA allows all users to use all frequency bands (1.2288 MHz) at the same time, the signals sent by other users are considered to be noise, and it does not need to take the signal collision problem into consideration. The voice coding technology in CDMA provides better call quality than that of the current GSM, and can reduce the ambient noise when the user performs conversation, making the conversation more clear. For the sake of security performance, CDMA not only has good authentication mechanism, but also provides greatly improved anti-eavesdropping capability by its transmission feature of using codes to distinguish users. A CDMA positioning technology is a positioning technology based on a location-based service, which uses a client/server architecture, and features simple frequency planning. Users are distinguished by using different sequence codes; therefore, the same CDMA carrier can be used in neighboring cells, and the network can be flexibly planned and easily extended.

As for Orthogonal Frequency Division Multiple Access (OFDMA), the most significantly difference between the OFDM technology and the OFDMA technology lies in the access technology. OFDM transmission generally needs to occupy all available subcarriers, while OFDMA uses the existing uplink multiple access of OFDM, wherein each user occupies different subcarriers, and users are separated according to subcarriers. OFDMA provides improved multi-user communications, especially for cellular phones and other mobile devices. A downlink data stream is divided into logical data streams, and these data streams can be connected to user terminals having different channel features by using different modulation and coding schemes and at different signal frequencies. Subchannels of an uplink data stream are used for multiple access, and an uplink data stream is transmitted using a Media Access Protocol allocation subchannel sent in the downlink. OFDMA is a multi-carrier digital modulation technology which can achieve high spectrum utilization and has obvious advantages in resisting the multi-path effect, frequency selective fading or narrowband interference. OFDMA is applicable to currently mainstream 4G systems (WiMAX/LTE).

Currently, the above technologies are mostly used in a centralized network, and use the same division access technology for communication between a base station and a terminal, which belongs to a centralized network. If the center of the centralized network is damaged, the whole system will collapse.

Currently, decentralized self-configuring networks adopt the Mesh-OFDM (WiFi) technology. Obviously, currently WiFi-Mesh self-configuring networks are limited in terms of spectrum utilization and resource allocation flexibility, and though having functions of self-configuring networks, they have low data transmission rate and resource sharing capability, which cannot satisfy the construction of emergency self-configuring networks that have high requirements on capacity and sharing.

### SUMMARY

A technical problem to be solved by the present invention is to provide an OFDMA system based on a Mesh network and a control method, to solve the problem of low spectrum utilization and uneven resource allocation in prior art.

The present invention is implemented as follows: An OFDMA system based on a Mesh network, including a Mesh network and one or more orthogonal and nonoverlapping data blocks divided on a time domain and a frequency domain, the Mesh network including one or more nodes, wherein each node is connected with one or more other nodes, and the node is used for receiving a synchronization signal and transmitting and sharing data;

the data blocks are configured with a reserved gap in front of the time domain, and the reserved gap is used for synchronization between/among devices of the nodes; and

the one or more nodes include a control node, and synchronization signals corresponding to the nodes are connected to the control node, so that signals from the nodes are synchronized with a signal from the control node; when none of the remaining nodes in a same Mesh network can receive a GPS clock signal for synchronization, the control node is responsible for managing and coordinating synchronization of signals from all the nodes inside the Mesh network; the control node controls and coordinates transmission and scheduling of data blocks corresponding to each of the nodes by using a communication protocol; and the control node is further used for controlling and managing, in a same time domain and frequency domain, data blocks required together in the Mesh network and their arrangement forms, and at the same time adding a synchronization frame header in front of each frame in the time domain, so that other nodes perform, within the reserved gap and after the synchronization frame header of the control node, data extraction according to required data blocks, and simultaneously transmit extracted data blocks to other nodes in a broadcast manner within a time during which data extraction is not performed.

Further, the Mesh network has GPS antennas, and the GPS antennas are separately disposed on each node and are used for receiving a GPS clock synchronization signal; and when all the nodes inside the Mesh network can normally receive a GPS clock synchronization signal, the synchronization frame header is correspondingly a GPS synchronization frame header.

Further, the control node is a node that is temporarily assigned in the Mesh network, and can dynamically change according to a real-time topology status of the Mesh network.

Further, the control node is a relay control node, and the relay control node is a node that is closest to a physical position between two Mesh networks, and is used for synchronizing frame structures of two Mesh networks that are not in synchronous communication, and re-arranging the two Mesh networks in a same time domain and frequency domain; and the two Mesh networks that are not in synchronous communication are originally independent of each other and have respective edge nodes that satisfy a geographical location condition for establishing mutual communication, and the two Mesh networks are used for detecting whether each node can normally receive a GPS clock synchronization signal.

Further, the relay control node is a node having a GPS antenna.

The present invention further provides a control method for an OFDMA system based on a Mesh network, wherein the OFDMA system includes: a Mesh network having one or more nodes, and one or more orthogonal and nonoverlapping data blocks divided on a time domain and a frequency domain, and the control method specifically includes the following steps:

step 1: connecting each of the one or more nodes with one or more other nodes, wherein the node is used for receiving a synchronization signal and transmitting and sharing data;

step 2: configuring the data blocks with a reserved gap in front of the time domain, wherein the reserved gap is used for synchronization between/among devices of the nodes;

step 3: selecting one node from the one or more nodes as a control node, wherein a synchronization signal corresponding to the node is connected to the control node; when none of the remaining nodes in a same Mesh network can receive a GPS clock signal for synchronization, the control node is responsible for managing and coordinating synchronization of signals of all the nodes inside the Mesh network; the control node controls and coordinates transmission and scheduling of data blocks corresponding to the nodes by using a communication protocol; and the control node can further control and manage, in the same time domain and frequency domain, data blocks required together in the Mesh network and their arrangement forms; and

step 4: adding, by the control node, a synchronization frame header in front of each frame in the time domain, and at the same time, causing other nodes to perform, within the reserved gap and after the synchronization frame header of the control node, data extraction according to required data blocks, and simultaneously transmit extracted data blocks to other nodes in a broadcast manner within a time during which data extraction is not performed.

Further, the control method further includes step 5: adding GPS antennas used for receiving a GPS clock synchronization signal to the Mesh network, wherein the GPS antennas are separately disposed on each node and are used for receiving a GPS clock synchronization signal; and when all the nodes inside the Mesh network can normally receive a GPS clock synchronization signal, the synchronization frame header is correspondingly a GPS synchronization frame header.

Further, the control node in the step 3 is a node that is temporarily assigned in the Mesh network, and can dynamically change according to a real-time topology status of the Mesh network.

Further, the control node in the step 3 is a relay control node, and the relay control node is a node that is closest to a physical position between two Mesh networks, and is used for synchronizing frame structures of two Mesh networks that are not in synchronous communication, and re-arranging the two Mesh networks in a same time domain and frequency domain; and the two Mesh networks that are not in synchronous communication are originally independent of each other and have respective edge nodes that satisfy a geographical location condition for establishing mutual communication, and the two Mesh networks are used for detecting whether each node can normally receive a GPS clock synchronization signal.

Further, the relay control node is a node having a GPS antenna.

Compared with the prior art, the present invention has the following beneficial effects: By combining the Mesh network and the latest OFDMA technology, spectrum utilization of Mesh network is significantly improved, resource sharing of a self-configuring network is greatly improved, and high-efficiency, high-resolution and high-quality image and video sharing and transmission between units in a self-configuring network can be achieved.

### BRIEF DESCRIPTION OF THE DRAWINGS

FIG. 1 is a schematic structural diagram of an OFDMA system in an indoor application scenario according to an embodiment of the present invention;

FIG. 2 is a schematic structural diagram of an OFDMA system in an outdoor application scenario according to an embodiment of the present invention; and

FIG. 3 is a schematic structural diagram of an OFDMA system in a hybrid indoor and outdoor application scenario according to an embodiment of the present invention.

### DETAILED DESCRIPTION OF EMBODIMENTS

To make the objectives, technical solutions and advantages of the present invention more comprehensible, the present invention is further described in detail through embodiments with reference to the accompanying drawings. It should be understood that specific embodiments described herein are merely used to explain the present invention, and are not intended to limit the present invention.

The present invention greatly improves spectrum utilization and the flexibility of resource allocation by combining the Mesh network and the latest OFDMA technology.

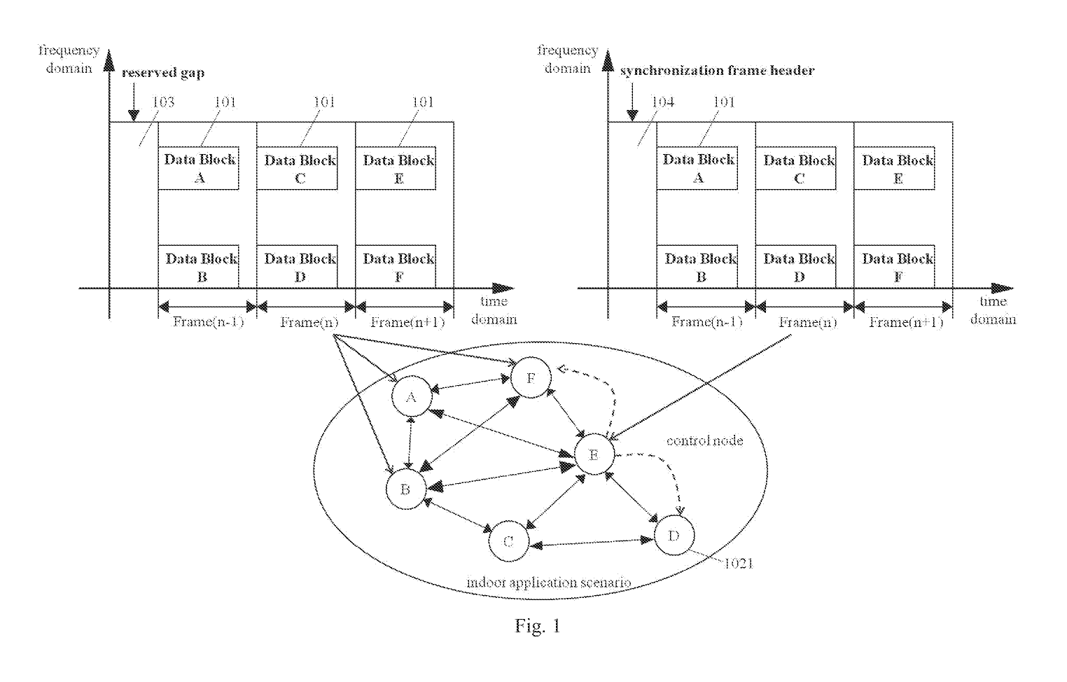

FIG. 1 shows a preferred embodiment of the present invention, wherein an OFDMA system based on a Mesh network includes a Mesh network 102 and orthogonal and nonoverlapping data blocks 101 divided on a time domain and a frequency domain. Several nodes 1021 are included inside the Mesh network 102, each node being connected with one or more other nodes, and the node 1021 being used for receiving a synchronization signal, transmitting and sharing data, and implementing a function of synchronizing the sending and reception of nodes. The data blocks 101 are configured with a reserved gap 103 in front of the time domain, the reserved gap 103 is used for synchronization between/among devices of the nodes, and the data blocks 101 are used for storing video image data. The several nodes 1021 include a control node, and synchronization signals corresponding to the nodes 1021 are connected to the control node, so that signals from the nodes 1021 are synchronized with a signal from the control node. When none of the remaining nodes in a same Mesh network can receive a GPS clock signal for synchronization, the control node is responsible for managing and coordinating synchronization of signals from all the other nodes inside the Mesh network. The control node is responsible for controlling, coordinating and allocating transmission and scheduling of data blocks corresponding to the nodes by using a communication protocol. The control node is further used for controlling and managing, in the same time domain and frequency domain, data blocks required together in the Mesh network 102 and their arrangement forms, and at the same time adding a synchronization frame header 104 in front of each frame in the time domain, so that other nodes perform, within the reserved gap 103 and after the synchronization frame header 104 of the control node, data extraction according to required data blocks 101, and simultaneously transmit extracted data blocks to other nodes in a broadcast manner within a time during which data extraction is not performed, so as to increase the transmission efficiency of broadcast data such as audio and videos.

### Example 1

In an indoor application scenario, as shown in FIG. 1, no GPS synchronization signal can be acquired in any Mesh network 102; in this case, any node in the network can be selected as a control node, for example, node E is selected as the control node. The control node is a node that is temporarily assigned in the network, and can dynamically change according to a real-time topology status of the Mesh network. Same synchronization signals with node A, node B, node C, node D and node F are connected to the control node E, so that signals of other nodes are synchronized with a signal of the control node E. The control node E is responsible for controlling, coordinating and allocating transmission and scheduling of data blocks corresponding to each of the nodes by using a communication protocol. In the same time domain, all nodes (including the control node) inside the Mesh network 102 broadcast identical data to the outside, and upon reception, a device corresponding to each node receives a corresponding part of data from the sequence of broadcast data according to needs.

### Example 2

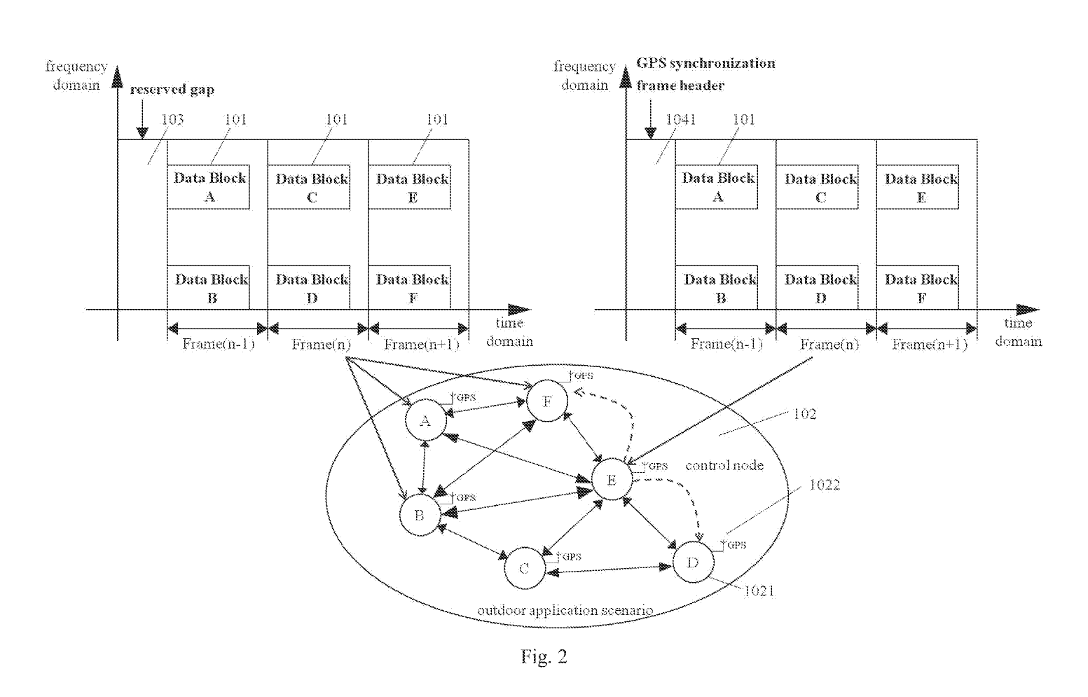

In an outdoor application scenario, as shown in FIG. 2, the nodes of units in all MESH networks 102 are installed with GPS antennas 1022, the GPS antennas 1022 are separately disposed on each node, and by means of the GPS antennas 1022, all the nodes can acquire a GPS clock synchronization signal 1022, respectively. When all the nodes inside the Mesh network can normally receive a GPS clock synchronization signal, the synchronization frame header is correspondingly a GPS synchronization frame header. As shown in FIG. 2, node A, node B, node C, node D, node E, and node F are each provided with a GPS antenna 1022. In this case, any node in the network can be selected as a control node, for example, node E is selected as the control node. The control node is a node that is temporarily assigned in the network, and can change its role at any time. The control node E having a GPS antenna is mainly responsible for controlling, coordinating and allocating transmission and scheduling of data blocks corresponding to the nodes by using a communication protocol. In the same time domain and frequency domain, the control node E is responsible for controlling and managing data blocks required together in the Mesh network and their arrangement forms, and at the same time adding a GPS synchronization frame header 1041 in front of each frame; after synchronizing the GPS synchronization frame header 1041 of the control node within the reserved gap 103, other ordinary nodes perform data extraction according to required data blocks, and share resources in the network with other nodes in other time.

### Example 3

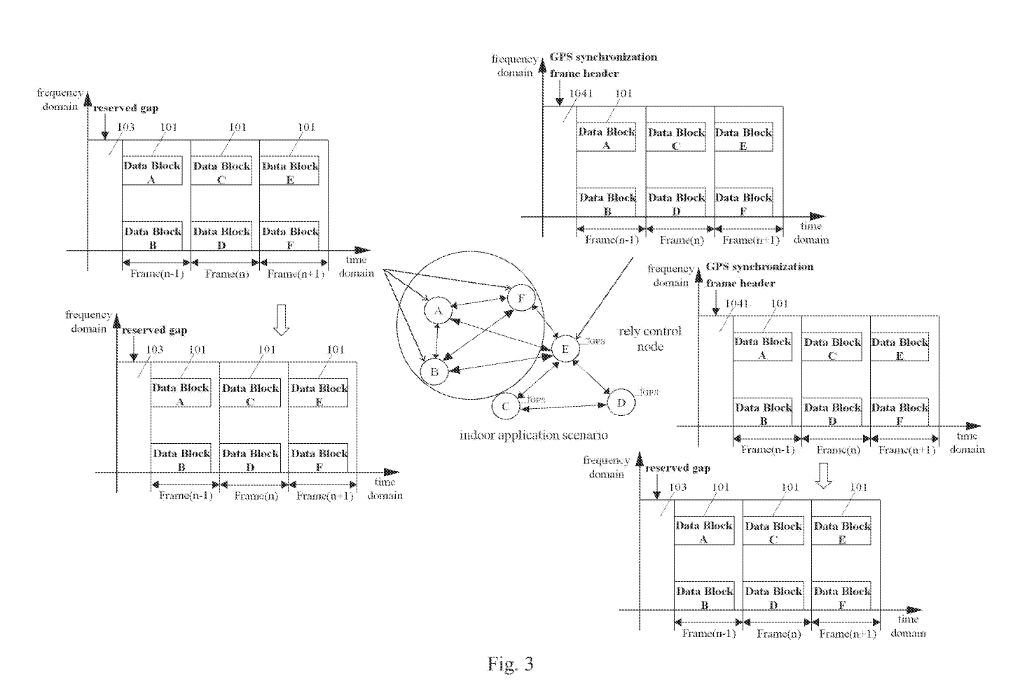

In an indoor, outdoor or hybrid application scenario, as shown in FIG. 3, when different Mesh networks require synchronous communication, frames structures sent by two unsynchronized nodes in the network are not the same, and in this case, the control node needs to be selected as a relay control node. Preferably, a node that is closest to a physical position between two Mesh networks is selected as the relay control node, and a node that can normally receive an outdoor GPS clock synchronization signal is preferably selected as the relay control node. For example, node E is selected as the relay control node. The relay control node is used for synchronizing frame structures of two Mesh networks that are not in synchronous communication, and re-arranging the two Mesh networks in a same time domain and frequency domain. The two Mesh networks that are not in synchronous communication are originally independent of each other and have respective edge nodes that satisfy a geographical location condition for establishing mutual communication, and a unified synchronization method is used between respective nodes of the two Mesh networks. The two Mesh networks are mainly used for detecting whether each node can normally receive a GPS clock synchronization signal. The relay control node is used for unifying data blocks and their arrangement forms, and at the same time adding a synchronization frame header in front of each frame; after synchronizing the frame header of the control node within the reserved gap, other ordinary nodes perform data extraction according to required data blocks, and share resources in the network with other nodes in other time.

Based on the above OFDMA system, a control method for an OFDMA system based on a Mesh network is provided. The OFDMA system includes: a Mesh network having several nodes, and several orthogonal and nonoverlapping data blocks divided on a time domain and a frequency domain, and the control method specifically includes the following steps: step 1: connecting each of the several nodes with one or more other nodes, wherein the node is used for receiving a synchronization signal and transmitting and sharing data; step 2: configuring the data blocks with a reserved gap in front of the time domain, wherein the reserved gap is used for synchronization between/among devices of the nodes; step 3: selecting one node from the several nodes as a control node, wherein a synchronization signal corresponding to the node is connected to the control node; when none of the remaining nodes in a same Mesh network can receive a GPS clock signal for synchronization, the control node is responsible for managing and coordinating synchronization of signals of all the nodes inside the Mesh network; the control node controls and coordinates transmission and scheduling of data blocks corresponding to the nodes by using a communication protocol; and the control node can further control and manage, in the same time domain and frequency domain, data blocks required together in the Mesh network and their arrangement forms; and step 4: adding, by the control node, a synchronization frame header in front of each frame in the time domain, and at the same time, causing other nodes to perform, within the reserved gap and after the synchronization frame header of the control node, data extraction according to required data blocks, and simultaneously transmit extracted data blocks to other nodes in a broadcast manner within a time during which data extraction is not performed.

The control method further includes step 5: adding GPS antennas used for receiving a GPS clock synchronization signal to the Mesh network, wherein the GPS antennas are separately disposed on each node and are used for receiving a GPS clock synchronization signal. When all the nodes inside the Mesh network can normally receive a GPS clock synchronization signal, the synchronization frame header is correspondingly a GPS synchronization frame header.

The control node in the step 3 is a node that is temporarily assigned in the Mesh network, and can dynamically change according to a real-time topology status of the Mesh network. The control node in the step 3 is a relay control node, and the relay control node is a node that is closest to a physical position between two Mesh networks, and is used for synchronizing frame structures of two Mesh networks that are not in synchronous communication, and re-arranging the two Mesh networks in a same time domain and frequency domain. The relay control node has a GPS antenna. The two Mesh networks that are not in synchronous communication are originally independent of each other and have respective edge nodes that satisfy a geographical location condition for establishing mutual communication, and a unified synchronization method is used between respective nodes of the two Mesh networks. The two Mesh networks are mainly used for detecting whether all the nodes in the Mesh networks can normally receive a GPS clock synchronization signal.

The OFDMA system based on a Mesh network of the present invention and the control method therefor can significantly change the current status of low spectrum utilization and low transmission and sharing efficiency of MESH WIFI networks, and by implementing the OFDMA system, can provide a quick, effective and easy-to-build high-efficiency sharing MESH network, which is suitable for sharing information in public security, firefighting, military emergency networking and field coordination tasks.

The above descriptions are merely preferred embodiments of the present invention, and are not intended to limit the present invention. Any modifications, equivalent replacements or improvements made without departing from the spirit and principle of the present invention shall be encompassed in the protection scope of the present invention.

What is claimed is:

1. An OFDMA system based on a Mesh network comprising a Mesh network and one or more orthogonal and nonoverlapping data blocks divided on a time domain and a frequency domain, the Mesh network comprising one or more nodes, wherein each node is connected with one or more other nodes, and the node is used for receiving a synchronization signal and transmitting and sharing data;
the data blocks are configured with a reserved gap in front of the time domain, and the reserved gap is used for synchronization between/among devices of the nodes; and
the one or more nodes comprise a control node, and synchronization signals corresponding to the nodes are connected to the control node, so that signals from the nodes are synchronized with a signal from the control node; when none of the remaining nodes in a same Mesh network can receive a GPS clock signal for synchronization, the control node is responsible for managing and coordinating synchronization of signals of all the nodes inside the Mesh network; the control node controls and coordinates transmission and scheduling of data blocks corresponding to the nodes by using a communication protocol; and the control node is further used for controlling and managing, in the same time domain and frequency domain, data blocks required together in the Mesh network and their arrangement forms, and at the same time adding a synchronization frame header in front of each frame in the time domain, so that other nodes perform, within the reserved gap and after the synchronization frame header of the control node, data extraction according to required data blocks, and simultaneously transmit extracted data blocks to other nodes in a broadcast manner within a time during which data extraction is not performed.

2. The OFDMA system according to claim 1, wherein the Mesh network has GPS antennas, and the GPS antennas are separately disposed on each node and are used for receiving a GPS clock synchronization signal; and when all the nodes inside the Mesh network can normally receive a GPS clock synchronization signal, the synchronization frame header is correspondingly a GPS synchronization frame header.

3. The OFDMA system according to claim 1, wherein the control node is a node that is temporarily assigned in the Mesh network, and can dynamically change according to a real-time topology status of the Mesh network.

4. The OFDMA system according to claim 1, wherein the control node is a relay control node, and the relay control node is a node that is closest to a physical position between two Mesh networks, and is used for synchronizing frame structures of two Mesh networks that are not in synchronous communication, and re-arranging the two Mesh networks in a same time domain and frequency domain; and the two Mesh networks that are not in synchronous communication are originally independent of each other and have respective edge nodes that satisfy a geographical location condition for establishing mutual communication, and the two Mesh networks are used for detecting whether each node can normally receive a GPS clock synchronization signal.

5. The OFDMA system according to claim 4, wherein the relay control node has a GPS antenna.

6. A control method for an OFDMA system based on a Mesh network, wherein the OFDMA system comprises a Mesh network having one or more nodes, and one or more orthogonal and nonoverlapping data blocks divided on a time domain and a frequency domain, and the control method specifically comprises the following steps:
step 1: each of the one or more nodes being connected with one or more other nodes, wherein the node is used for receiving a synchronization signal and transmitting and sharing data;
step 2: the data blocks being configured with a reserved gap in front of the time domain, wherein the reserved gap is used for synchronization between/among devices of the nodes;
step 3: one node being selected from the one or more nodes as a control node, wherein a synchronization signal corresponding to the node is connected to the control node; when none of the remaining nodes in a same Mesh network can receive a GPS clock signal for synchronization, the control node is responsible for managing and coordinating synchronization of signals of all the nodes inside the Mesh network; the control node controls and coordinates transmission and scheduling of data blocks corresponding to the nodes by using a communication protocol; and the control node can further control and manage, in the same time domain and frequency domain, data blocks required together in the Mesh network and their arrangement forms; and
step 4: a synchronization frame header being added by the control node in front of each frame in the time domain, and at the same time, other nodes being caused to perform, within the reserved gap and after the synchronization frame header of the control node, data extraction according to required data blocks, and simultaneously transmit extracted data blocks to other nodes in a broadcast manner within a time during which data extraction is not performed.

7. The control method for an OFDMA system based on a Mesh network according to claim 6, wherein the control method further comprises step 5: GPS antennas used for receiving a GPS clock synchronization signal being added to the Mesh network, wherein the GPS antennas are separately disposed on each node and are used for receiving a GPS clock synchronization signal; and when all the nodes inside the Mesh network can normally receive a GPS clock synchronization signal, the synchronization frame header is correspondingly a GPS synchronization frame header.

8. The control method for an OFDMA system based on a Mesh network according to claim 6, wherein the control node in the step 3 is temporarily assigned in the Mesh network, and can dynamically change according to a real-time topology status of the Mesh network.

9. The control method for an OFDMA system based on a Mesh network according to claim 6, wherein the control node in the step 3 is a relay control node, and the relay control node is a node that is closest to a physical position between two Mesh networks, and is used for synchronizing frame structures of two Mesh networks that are not in synchronous communication, and re-arranging the two Mesh networks in a same time domain and frequency domain; and the two Mesh networks that are not in synchronous communication are originally independent of each other and have respective edge nodes that satisfy a geographical location condition for establishing mutual communication, and the two Mesh networks are used for detecting whether each node can normally receive a GPS clock synchronization signal.

10. The control method for an OFDMA system based on a Mesh network according to claim 9, wherein the relay control node has a GPS antenna.
